(19) United States
(12) Patent Application Publication
(10) Pub. No.: US 2025/0278891 A1
(43) Pub. Date: Sep. 4, 2025

(54) 3D VISUALISATION OF DEPOSITS

(71) Applicant: SHELL USA, INC., Houston, TX (US)

(72) Inventors: Vishal Raju AHUJA, Bangalore North (IN); Jan Phillipp Koether, Hamburg (DE); Joost Jacobus KROON, Amsterdam (NL); Saumil MERCHANT, Bangalore (IN); Sathya NARAYANAN, Bangalore North (IN)

(21) Appl. No.: 18/863,797

(22) PCT Filed: May 24, 2023
(86) PCT No.: PCT/EP2023/063917

§ 371 Date: Nov. 7, 2024

(30) Foreign Application Priority Data
May 30, 2022 (IN) 202241030889

(51) Int. Cl. G06T 17/00

(52) U.S. Cl. CPC G06T 17/00

(57) ABSTRACT

A method includes for i) creating a 3D model of the machine part after use: ii) mounting the machine part on a means for rotation; iii) obtaining an image of an initial section of an external surface of said machine part: iv) rotating the machine part by a specific amount; v) obtaining an image of a further section of the external surface that overlaps with the initial section; vi) repeating steps iii) to v) until the whole external surface has been imaged; vii) removing the overlapping sections of the images and creating a single continuous image of the external surface; viii) assigning a value to each pixel in the image related to the presence of deposits therein; and ix) applying the dataset obtained in step viii) to the 3D model created in step i) to produce an accurate 3D representation for visualisation and quantification of the deposits on the machine part.

### FIELD OF THE INVENTION

This invention relates to an improved process and system for the quantification and 3D visualisation of deposits on a used machine part.

### BACKGROUND OF THE INVENTION

A widely used method for determining the quality of one or more lubricant compositions is to carry out field trials or bench tests on machines using said lubricant compositions. After the trial or test, machine parts are removed and evaluated for cleanliness and deposits. For example, after field trials of engines, the pistons are removed from the engines and evaluated for cleanliness. During the field trials, coke will form in the combustion chambers of the engines and accumulate on the surfaces of the pistons. A deposit structure will, therefore, build up over time. The deposits on the ring lands and inside the ring grooves of the pistons can increase friction and wear during engine operation.

In the case of severe deposits in the ring grooves, free movement of the piston rings can be impeded. This can lead to higher friction, blow-by or even piston seizure and piston-ring breakage. By using high-quality lubricant compositions, the formation of deposits in the combustion chamber can be mitigated and existing deposits can even be removed. Thus, the quality of a lubricant composition for use in an engine is closely linked with the deposits accumulated on the pistons during engine operation. Being able to visualise and measure these deposits accurately and consistently is, therefore, a desirable aim.

Currently, the established method for evaluating the deposits on pistons to assess the performance of lubricant compositions is based on an expert rating system. Said system involves disassembly of the test engine and an assessment of the deposits on the pistons by an expert. For this evaluation, typically the top land, the first ring groove and the second land (see FIG. 1) are analysed. Grades are assigned to the structure (discoloration) and the thickness of the deposits on the pistons. In general, the thicker and the more structured the deposits appear, the worse the grades are.

Despite being a widely used and established rating system, this system has downsides such as the subjectivity of the human raters and the inability to provide a quantifiable, physical value to the deposits. Moreover, the grading reports for piston deposits contain great amounts of cumbersome information. The comparison of lubricant compositions can be complicated and may be inaccessible to a lay person, such as a customer looking to choose between two lubricant types. It would, therefore, be highly desirable to create a simpler system for evaluating piston deposits with a quantifiable result.

The use of laser scanning to develop a 3D model of a piston before and after use in a field trial has been reported, for example as offered by SouthWest Research Institute: www.swri.org/sites/default/files/brochures/precision-analysis.pdf. Such 3D models may be used to analyse the piston deposits accumulated during the trial and provide comparisons to both lubricant developers and customers. However, such technology does not in itself have the resolution required for accurate quantification of very fine deposits or smaller pistons, such as those used in motorcycle engines. For such an application, a new methodology is required.

### SUMMARY OF THE INVENTION

The present invention therefore provides a method for the analysis of deposits accumulated on a machine part during its use while lubricated with a lubricating composition, said method comprising the steps of:
i) using a 3D scanner to create a 3D model of the machine part after use;
ii) mounting the machine part on a means for rotation;
iii) obtaining a digital microscope image of an initial section of the external surface of said machine part;
iv) rotating the machine part about its central axis by a specific amount;
v) obtaining a digital microscope image of a further section of the external surface of said machine part, said further section of the external surface overlapping with the initial section of the external surface of the machine part;
vi) repeating steps iii) to v) until the whole external surface of the machine part has been imaged;
vii) removing the overlapping sections of the digital microscope images and creating a single continuous image of the external surface of the machine part;
viii) processing said single continuous image by assigning a value to each pixel in the image related to the presence of deposits therein and, optionally, the thickness of the deposits; and
ix) applying the dataset obtained in step viii) to the 3D model created in step i) to produce an accurate 3D representation for visualisation and quantification of the deposits on the machine part.

### BRIEF DESCRIPTION OF THE DRAWINGS

FIG. 1 shows a typical piston with the lands and grooves indicated.

FIG. 2 shows a 3D model of a piston created using a 3D laser scanner.

FIG. 3 shows the set up used to obtain the digital microscope images.

FIG. 4 shows raw digital microscope images of a used piston.

FIG. 5 shows processed microscope images of a used piston.

### DETAILED DESCRIPTION OF THE INVENTION

The present inventors have developed a method for accurately visualising the deposits formed on a machine part during its use. The method is particularly useful for the visualisation and assessment of small machine parts and fine deposits. The method of the present invention allows assessment and quantification of said deposits allowing assessment of lubricant compositions used to lubricate the machine part. Deposits relating to the use of fuels in engines may also be assessed, allowing comparison between fuel compositions.

The present method is relevant for any machine part used under lubrication. The machine part may be any moving part operated in the presence of a lubricating composition. The machine part may be from an industrial machine or an engine, including automotive, aviation and marine engines. Of particular relevance for the method of the present invention are pistons, in particular small pistons, even more in particular pistons from a motorcycle engine.

The first step in the method of the present invention is the creation of a 3D model of a machine part after use. This can be achieved by scanning the piston before and after the field trials using 3D laser or blue light scanning technology. Any suitable 3D scanning technology is applicable to the method of the present invention. It will be readily understood by the skilled person that a finer wavelength source would be required for smaller machine parts, in order to accurately image small grooves, or for finer deposits.

Suitably, before the machine parts are scanned, they may be sprayed with a coating to prevent reflections, which can distort the recording of the image. For alignment, it is useful to place measuring points on the machine part surfaces as reference locations. The scanner is typically calibrated using a calibration plate.

Typically, the whole machine part may be scanned at a coarser initial resolution. A second scan is then carried out at a higher resolution to obtain a more accurate image of finer details, such as the piston grooves and lands when the machine part is a piston. After recording the scan images, unwanted data is deleted and the measuring series is polygonised. The resulting data is then analysed computationally for each machine part before and after the field trials, in order to create virtual 3D models of the machine parts after use.

The machine part is then mounted on a means for rotation allowing said machine part to be rotated about its central axis and for digital images of each section of the external surface of said machine part to be collected using a high-resolution digital microscope. The resolution of the microscope to be used and the resolution of the images to be taken will be readily determined on the basis of the size of the machine part, the field of view for each image and the size or fineness of the deposits to be visualised and/or quantified. Further, the shape of the machine part will also be relevant when determining how many images will be required to accurately assess the full surface area of the machine part and thus the resolution to be used. A “4K” high resolution microscope may be suitable, but a lower resolution microscope may also be used depending on these factors.

In order to collect a complete digital image of the entire circumference of the external surface of a machine part, it is necessary to obtain an image of an initial section before rotating the machine part by a controlled amount and then obtaining an image of a further, slightly overlapping, section. This process is then repeated a number of times until the entire external surface of the machine part has been imaged.

The number of sections required will depend on the size of the machine part, the size of the deposits and the resolution at which the microscope images are being captured. For example, for an automotive or motorcycle piston at least 10, preferably at least 15, suitably about 20 images may be collected. Clearly, any number of overlapping images may be collected, but for an automotive or motorcycle piston suitably no more than 40, preferably no more than 30 images are collected. It will be readily understood that for a larger machine part, a larger number of images may be required.

The controlled amount that the machine part is rotated will be determined by the number of images required to produce a complete image of the external surface of the machine part. For example, if 20 images are required, a rotation of about 18 between the centre of each image is suitable.

Each digital image is acquired in such a way that the deposits are kept in focus and there is a small overlap between consecutive images. The images must then be processed in order to merge the series of images in a way that the overlapping regions between images are removed. It may be most efficient to carry out image registration on only a portion of the image of the machine part. For example, in the embodiment that the machine part is a piston, the portion of the image covering a single land may be used to match deposit patterns between consecutive images. This information can then be used to determine how many rows of pixels need to be removed from one end of an entire image. Most simply, this image registration process may be done using an algorithm on a computer and is applied to each pair of consecutive images. The images are then combined in order to create a single image of the entire surface area of the machine part.

The images are then analysed to identify the deposits. This may be achieved by assigning a value to each pixel in the image. Classical image processing algorithms may be applied to assign a value to each pixel on the basis of the colour of each pixel. Alternatively, a small number of pixels may be manually labelled and a machine learning algorithm used to assign a value to each pixel.

Suitably, the deposits may be identified by assigning values to each pixel as “containing substantial deposit” or “containing little or no deposit”. Optionally, each pixel may be assigned a value on the basis of the amount of deposits with a range of values given depending on the amount of deposit present. This may be assigned in reference to the colour of each pixel.

The dataset obtained in step viii) is then applied to the 3D model. The resultant 3D representation of the used machine part provides an accurate representation of the deposits on the used machine part. Such a representation may then be used to assess the effectiveness of a particular lubricant composition and/or to demonstrate this to a customer. If a range of values are assigned to the thickness of the deposits in step viii) a quantitative assessment of the deposits may be carried out in an accurate manner, avoiding any subjectivity in the assessment of deposit formation.

A variety of tools may be created using the 3D representation of the used machine part. For example, the 3D representation may be visualised in a computer using any standard visualization software either installed on the system or via a web-browser, viewed on a screen or within any extended reality system (virtual reality system or augmented reality system). Alternatively, the model may be 3D printed.

### Detailed Description of the Drawings

The following drawings and descriptions thereof are intended to exemplify the method of the present invention and not to limit it. The drawings represent an embodiment of the present invention in which the machine part is a piston.

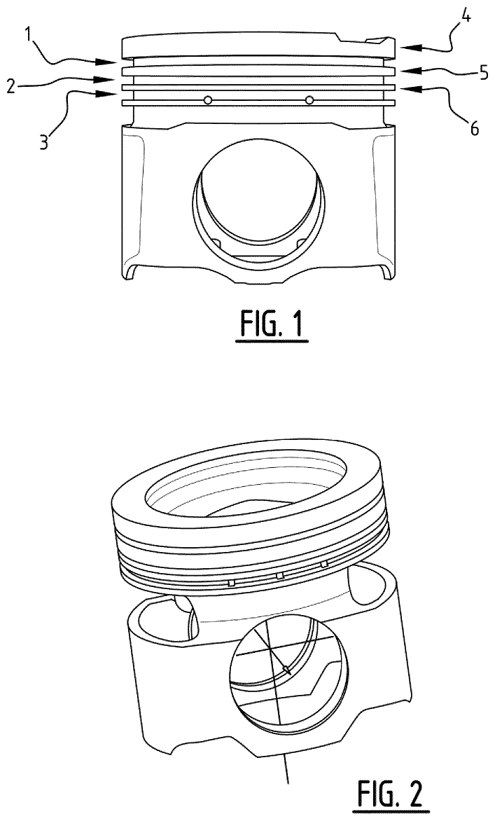

FIG. 1 provides an example of a typical piston. The first ring groove (1), second ring groove (2), third ring groove (3), the top land (4), second land (5) and third land (6) are clearly indicated. It is the deposit build up on each of these lands and grooves that can readily be assessed using the method of the present invention.

In this embodiment of the method of the present invention, a digital 3D model of a piston is made using blue light scans of the piston before and after use to produce a digital 3D piston model, as shown in FIG. 2.

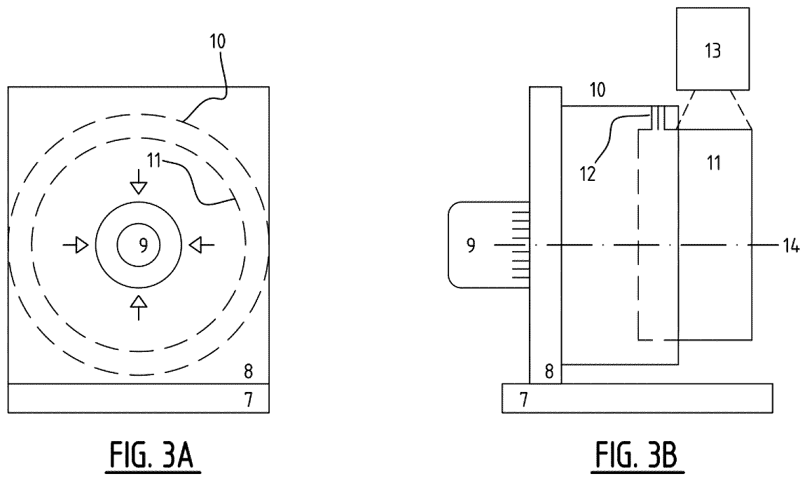

The used piston is then mounted on a means for rotation and a digital microscope image is obtained. FIGS. 3a and 3b illustrate different views of a typical means for rotation suitable for use in in order to take a series of digital microscope images. A base (7) supports an upright member (8). A means for rotating (9), such as a handle or knob, is supported by the upright member (8) and is attached through said upright member (8) to a holder (10). The piston (11) is firmly secured within the holder (10) by an attachment device (12) in a manner such that the grooves and lands (1 to 6) are clearly visible. The rotating means is positioned such that the field of view of a digital microscope (13) clearly covers a portion of the surface area of the piston (11) and a first image is taken. In order to capture images of the entire external surface of the piston, a series of digital images are taken with the piston having been rotated by a set amount between each image, said rotation having been achieved by rotation of the means for rotation (9) by a pre-set amount.

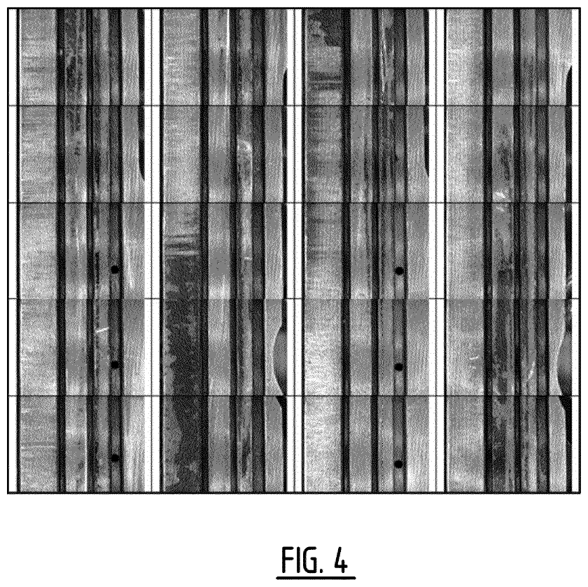

FIG. 4 shows a series of 20 images taken of a used piston. These images are then digitally combined, with any overlaps removed, to form a single complete image of the entire piston external surface.

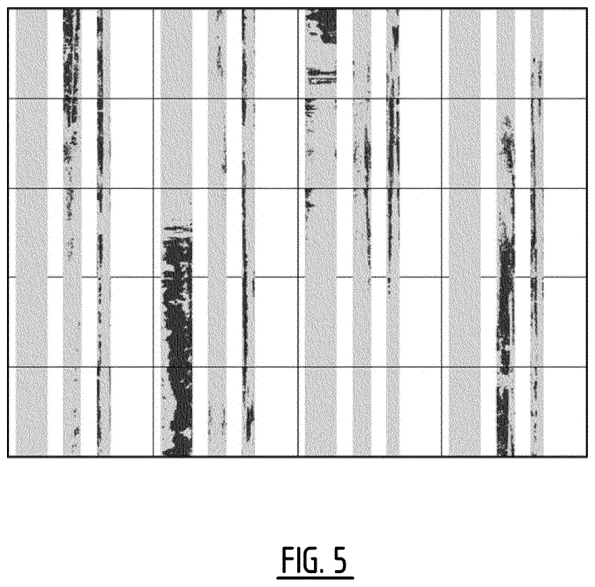

FIG. 5 illustrates a digitally processed image in which areas with substantial deposits are coloured black and those with little or no deposits are coloured grey. This is an example of assigning each pixel as “containing substantial deposit” or “containing little or no deposit”. In an alternative embodiment, each pixel may be assigned a value on the basis of the amount of deposit present and a grayscale or colour-based illustration may be created.

In the method of the present invention, the detailed deposit picture is combined with the 3D model of the piston in order to provide a tool for assessment of the used piston and, therefore, the effectiveness of the lubricant composition applied in the engine.

1. A method for the analysis of deposits on a machine part during its use while lubricated with a lubricating composition, said method comprising the steps of:
i) using a 3D scanner to create a 3D model of the machine part after use:
ii) mounting the machine part on a means for rotation;
iii) obtaining a digital microscope image of an initial section of an external surface of said machine part;
iv) rotating the machine part about its central axis by a specific amount;
v) obtaining a digital microscope image of a further section of the external surface, said further section of the external surface overlapping with the initial section of the external surface;
vi) repeating steps iii) to v) until the whole external surface has been imaged;
vii) removing the overlapping sections of the digital microscope images and creating a single continuous image of the external surface;
viii) obtaining a dataset by processing said single continuous image by assigning a value to each pixel in the single continuous image related to the presence of deposits therein and, optionally, the thickness of the deposits; and
ix) applying the dataset obtained in step viii) to the 3D model created in step i) to produce an accurate 3D representation for visualisation and quantification of the deposits on the machine part.

2. The method as claimed in claim 1, wherein said machine part is a piston used in an engine.

3. The method as claimed in claim 2, wherein the piston is a motorcycle piston.

4. The method as claimed in claim 1, wherein the total number of digital microscope images obtained is at least 10 and no more than 40.

5. The method as claimed in claim 1, wherein step viii) is carried out using a machine learning algorithm.

6. The method as claimed in claim 1, wherein the 3D representation is visualised within an extended reality system.

17. Use of the method of claim 1 in order to evaluate the lubricant composition.

8. Use of the method as claimed in claim 2, to evaluate a fuel composition used in said engine.
